(19) United States
(12) Patent Application Publication
(10) Pub. No.: US 2018/0157225 A1
(43) Pub. Date: Jun. 7, 2018

(54) APPARATUS AND METHOD FOR AUTOMATIC MODEL IDENTIFICATION FROM HISTORICAL DATA FOR INDUSTRIAL PROCESS CONTROL AND AUTOMATION SYSTEMS

(71) Applicant: Honeywell International Inc., Morris Plains, NJ (US)

(72) Inventors: Sanjay K. Dave, Bangalore (IN); Charles Q. Zhan, Chandler, AZ (US)

(21) Appl. No.: 15/790,392

(22) Filed: Oct. 23, 2017

Related U.S. Application Data
(60) Provisional application No. 62/430,160, filed on Dec. 5, 2016.

(51) Int. Cl. G05B 13/04; G06F 17/17; G06F 17/30

(52) U.S. Cl. CPC G05B 13/045; G06F 17/175; G05B 13/048; G05B 2219/33042; G05B 2219/37518; G05B 2219/32194; G06F 17/30513

(57) ABSTRACT

A method includes obtaining historical data associated with an industrial process, which is associated with multiple independent variables. The method also includes automatically excluding at least one portion of the historical data and automatically extracting data segments from at least one non-excluded portion of the historical data.

The method further includes iteratively performing model identification using the data segments to identify one or more models and using the model(s) to design, monitor, or tune at least one industrial process controller for the industrial process. Iteratively performing the model identification includes recursively analyzing the data segments to (i) select the data segment(s) associated with each variable that have a highest energy and provide a high signal to noise ratio and (ii) eliminate poorly performing segments associated with each variable. Iteratively performing the model identification also includes generating a model for each variable using the selected data segment(s) for that variable.

### CROSS-REFERENCE TO RELATED APPLICATION AND PRIORITY CLAIM

This application claims priority under 35 U.S.C. § 119(e) to U.S. Provisional Patent Application No. 62/430,160 filed on Dec. 5, 2016. This provisional application is hereby incorporated by reference in its entirety.

### TECHNICAL FIELD

This disclosure relates generally to industrial process control and automation systems. More specifically, this disclosure relates to an apparatus and method for automatic model identification from historical data for industrial process control and automation systems.

### BACKGROUND

Industrial process control and automation systems are often used to automate large and complex industrial processes. These types of control and automation systems routinely include process controllers and field devices like sensors and actuators. Some of the process controllers typically receive measurements from the sensors and generate control signals for the actuators.

Model-based industrial process controllers are one type of process controller routinely used to control the operations of industrial processes. Model-based process controllers typically use one or more models to mathematically represent how one or more properties within an industrial process respond to changes made to the industrial process. Multivariable process controllers are one type of model-based process controller that can be used to adjust multiple variables of an industrial process using one or more models. Other types of industrial process controllers that are commonly used include proportional-integral-derivative (PID) controllers.

### SUMMARY

This disclosure provides an apparatus and method for automatic model identification from historical data for industrial process control and automation systems.

In a first embodiment, a method includes obtaining historical data associated with an industrial process. The industrial process is associated with multiple independent variables. The method also includes automatically excluding at least one portion of the historical data and automatically extracting data segments from at least one non-excluded portion of the historical data. The method further includes iteratively performing model identification using the data segments to identify one or more models and using the one or more models to design, monitor, or tune at least one industrial process controller for the industrial process. Iteratively performing the model identification includes recursively analyzing the data segments to (i) select the data segment or segments associated with each independent variable that have a highest energy and provide a high signal to noise ratio and (ii) eliminate poorly performing segments associated with each independent variable. Iteratively performing the model identification also includes generating a model for each independent variable using the selected data segment or segments for that independent variable.

In a second embodiment, an apparatus includes at least one processor configured to obtain historical data associated with an industrial process. The industrial process is associated with multiple independent variables. The at least one processor is also configured to automatically exclude at least one portion of the historical data and automatically extract data segments from at least one non-excluded portion of the historical data. The at least one processor is further configured to iteratively perform model identification using the data segments to identify one or more models and use the one or more models to design, monitor, or tune at least one industrial process controller for the industrial process. To iteratively perform the model identification, the at least one processor is configured to recursively analyze the data segments to (i) select the data segment or segments associated with each independent variable that have a highest energy and provide a high signal to noise ratio and (ii) eliminate poorly performing segments associated with each independent variable. To iteratively perform the model identification, the at least one processor is also configured to generate a model for each independent variable using the selected data segment or segments for that independent variable.

In a third embodiment, a non-transitory computer readable medium contains instructions that when executed cause at least one processing device to obtain historical data associated with an industrial process. The industrial process is associated with multiple independent variables. The medium also contains instructions that when executed cause the at least one processing device to automatically exclude at least one portion of the historical data and automatically extract data segments from at least one non-excluded portion of the historical data. The medium further contains instructions that when executed cause the at least one processing device to iteratively perform model identification using the data segments to identify one or more models and use the one or more models to design, monitor, or tune at least one industrial process controller for the industrial process. The instructions that when executed cause the at least one processing device to iteratively perform the model identification include instructions that when executed cause the at least one processing device to recursively analyze the data segments to (i) select the data segment or segments associated with each independent variable that have a highest energy and provide a high signal to noise ratio and (ii) eliminate poorly performing segments associated with each independent variable. The instructions that when executed cause the at least one processing device to iteratively perform the model identification also include instructions that when executed cause the at least one processing device to generate a model for each independent variable using the selected data segment or segments for that independent variable.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example device supporting automatic model identification from historical data for industrial process control and automation systems according to this disclosure;

FIGS. 3 through 5 illustrate example user interfaces showing various steps in a process supporting automatic model identification from historical data for industrial process control and automation systems according to this disclosure; and

FIG. 6 illustrates an example method for automatic model identification from historical data for industrial process control and automation systems according to this disclosure.

### DETAILED DESCRIPTION

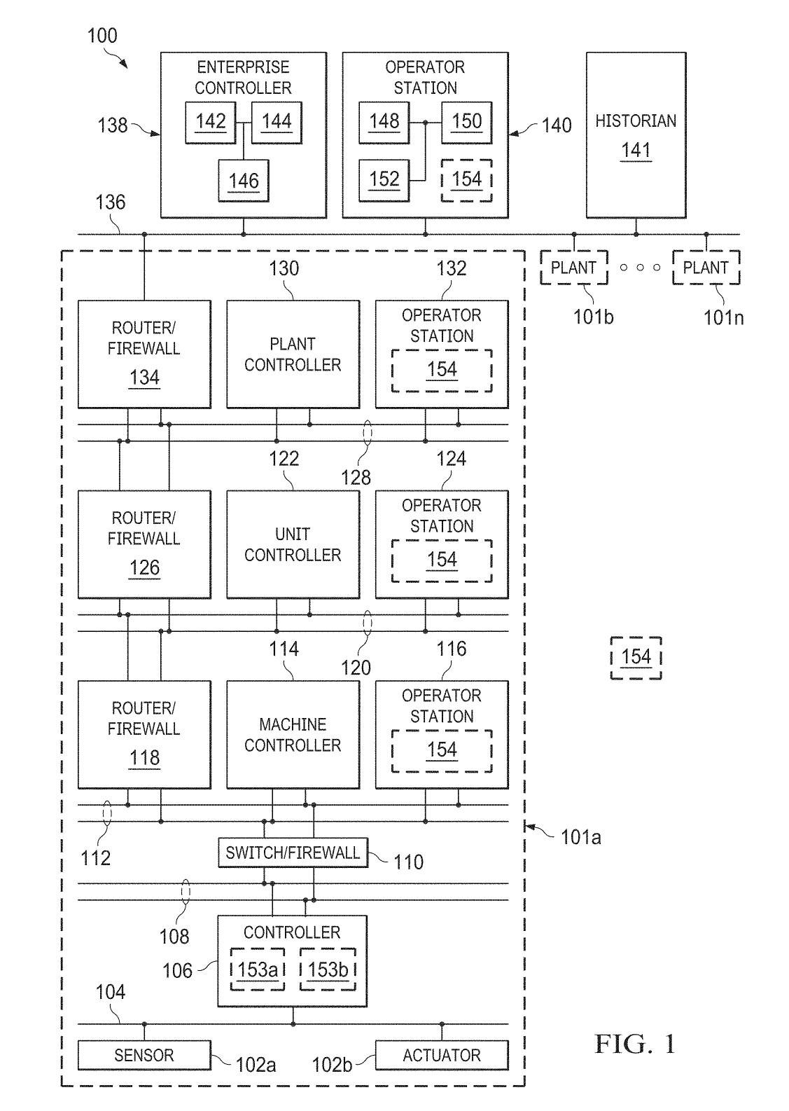

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a microcontroller, a proportional-integral-derivative (PID) controller, or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers. Each processing device 142, 148 includes any suitable computing or processing device, such as a microprocessor, microcontroller, digital signal processor (DSP), application specific integrated circuit (ASIC), field programmable gate array (FPGA), or discrete logic devices. Each memory 144, 150 includes any suitable volatile or non-volatile storage and retrieval device, such as a random access memory (RAM) or Flash memory. Each interface 146, 152 includes any suitable structure supporting communications over one or more communication paths.

Depending on the implementation, one or more controllers (such as the controllers 106) shown in FIG. 1 could operate using one or more models 153a or one or more tuning parameters 153b. Each model 153a mathematically represents how one or more properties within an industrial process respond to changes made to the industrial process. As noted above, model-based industrial process controllers are routinely used to control the operations of industrial processes, and multivariable process controllers can be used to adjust multiple variables of an industrial process. Model-based industrial process controllers can operate using controlled, manipulated, and disturbance variables. A controlled variable (CV) denotes a variable whose value is controlled to be at or near a desired value (setpoint) or within a desired range of values. A manipulated variable (MV) denotes a variable whose value is adjusted in order to alter one or more controlled variables. A disturbance variable (DV) denotes a variable whose value can be considered during control operations but generally cannot be modified. One or more models 153a can be used by a model-based process controller 106 to predict how to adjust the industrial process in order to achieve one or more desired results.

A tuning parameter 153b denotes a parameter that affects how a process controller operates to control an industrial process. For example, proportional-integral-derivative (PID) controllers can be used to control various aspects of industrial processes. PID controllers often need to be tuned to provide accurate control of the industrial processes, and this tuning typically occurs based on a current understanding of the dynamics of the industrial processes.

Unfortunately, the actual implementation of model-based multivariable process controllers or the tuning of PID controllers can be a time-consuming process. For example, the design or tuning of a process controller may require a large amount of time and effort to perturb an industrial process and use the associated data to identify dynamic models or behaviors of the industrial process.

Closed-loop system identification is one conventional technique by which industrial process models can be identified, but this approach often requires some initial estimate of an industrial process' behavior and perturbations. Also, process models are typically not time-invariant, meaning the process models often need to change over time as the behavior of an industrial process changes. Industrial processes can change over time due to a number of factors, such as fouling of system components or changes in feed materials used in the industrial process. Thus, “system identification” (the process of identifying one or more models for an industrial process) may be needed or required at multiple points in time, such as for initial implementation of process controllers and for adapting models or tuning controllers to the changing dynamic behaviors of an industrial process (while the process controllers are in operation).

In accordance with this disclosure, the system 100 includes or supports at least one model identification tool 154. The model identification tool 154 implements techniques that facilitate automatic model identification for the industrial process control and automation system 100. For example, the model identification tool 154 can use historical data associated with the industrial process control and automation system 100 (such as from the historian 141) in order to identify one or more models 153a for one or more industrial processes. The model identification tool 154 could then provide the one or more models 153a to at least one of the controllers 106, 114, 122, 130, 138 for use in controlling the one or more industrial processes. The model identification tool 154 could also or alternatively use the one or more models 153a to determine how to adjust one or more tuning parameters 153b of at least one of the controllers 106, 114, 122, 130, 138.

The use of historical data can help to reduce or eliminate the need for perturbing an industrial process in order to gather data, which would otherwise interfere with the operation of the industrial process. Moreover, the model identification techniques can be performed at various times, such as during initial controller design and during subsequent times to account for changing process dynamics.

The model identification tool 154 could be implemented in any suitable manner. For example, in some embodiments, the model identification tool 154 could be implemented using software or firmware instructions that are executed by one or more processors of at least one of the operator stations 116, 124, 132, 140. The model identification tool 154 could also be implemented separate from the operator stations, such as when the model identification tool 154 resides on and is executed by a standalone computer like a local or remote server. However, the model identification tool 154 could be implemented in any other suitable manner. Additional details regarding the operations of the model identification tool 154 are provided below.

Although FIG. 1 illustrates one example of an industrial process control and automation system 100, various changes may be made to FIG. 1. For example, a control and automation system could include any number of sensors, actuators, controllers, servers, operator stations, networks, models, tuning parameters, model identification tools, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which automatic model identification can be used. This functionality can be used in any other suitable device or system.

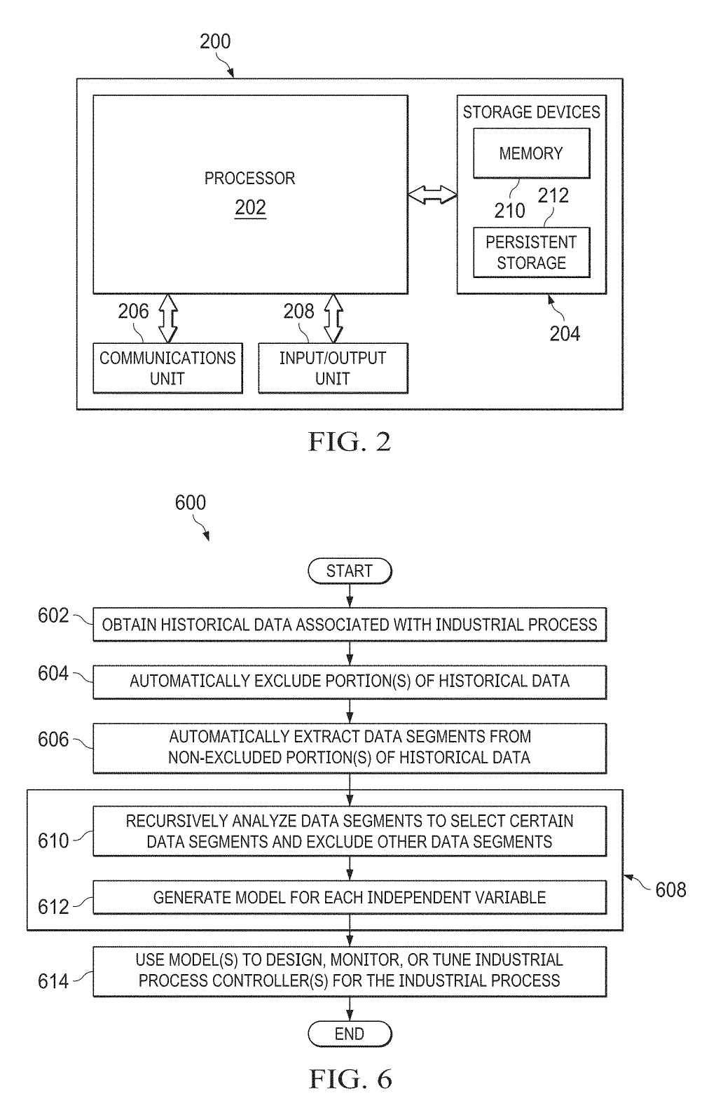

FIG. 2 illustrates an example device 200 supporting automatic model identification from historical data for industrial process control and automation systems according to this disclosure. For ease of explanation, the device 200 is described as representing any of the devices in FIG. 1 that can execute or otherwise support the use of the model identification tool 154. However, the model identification tool 154 could be executed or otherwise supported using any other suitable device or system.

As shown in FIG. 2, the device 200 includes at least one processor 202, at least one storage device 204, at least one communications unit 206, and at least one input/output (I/O) unit 208. Each processor 202 can execute instructions, such as those that may be loaded into a memory 210. The instructions could be used to implement automatic model identification from historical data for industrial process control and automation systems. Each processor 202 denotes any suitable processing device, such as one or more microprocessors, microcontrollers, DSPs, FPGAs, ASICs, or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 could include at least one network interface card or wireless transceiver facilitating communications over at least one wired or wireless network. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device.

Although FIG. 2 illustrates one example of a device 200 supporting automatic model identification from historical data for industrial process control and automation systems, various changes may be made to FIG. 2. For example, various components in FIG. 2 could be combined, further subdivided, or omitted and additional components could be added according to particular needs. As a particular example, if the automatic model identification techniques are implemented on a local or remote server, there may be no need for a local I/O unit 208. Rather, the local or remote server could be accessible over a network. Also, computing devices can come in a wide variety of configurations, and FIG. 2 does not limit this disclosure to any particular configuration.

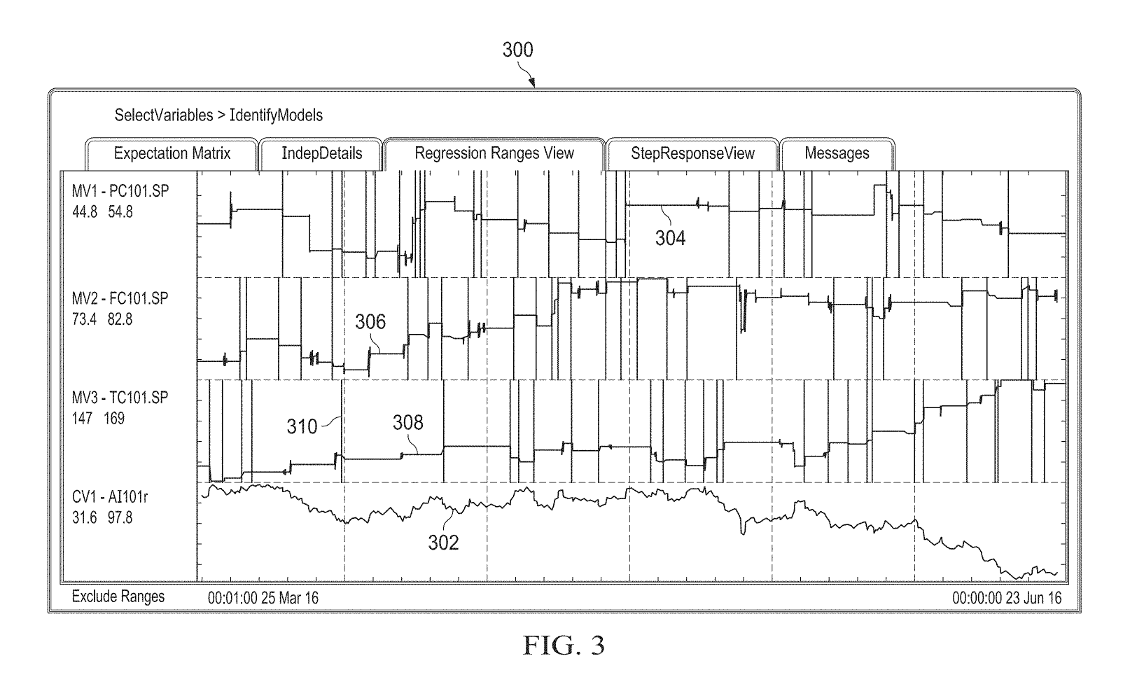

FIGS. 3 through 5 illustrate example user interfaces 300-500 showing various steps in a process supporting automatic model identification from historical data for industrial process control and automation systems according to this disclosure. For ease of explanation, the user interfaces 300-500 are described as being presented on the device 200 of FIG. 2 in the system 100 of FIG. 1. However, the user interfaces 300-500 could be used with any other suitable device or system.

Many industrial facilities are equipped with process historians, such as the historian 141. Process historians typically record time-series data of many or all variables associated with one or more industrial processes. When an industrial process is not under advanced control or any other form of supervisory control, a control room operator may make changes to the industrial process. When an industrial process is under advanced control or other form of supervisory control, an advanced controller manipulates industrial process variables. In either case, these changes can be recorded in one or more process historians.

Model identification for an industrial process can be performed using this recorded historical data. However, there are various problems that affect conventional model identification techniques. These problems include:
low informational content in the historical data;
an inability to control the signal to noise ratio (SNR), meaning disturbance energy content (such as in low frequencies) can overwhelm the data;
correlated MV moves, either by an operator or by a supervisory controller;
MV moves correlated to unmeasured disturbances, causing a false inverse in a model;
bad measurements or abnormal data segments;
a difficulty in assessing model quality; and
a need to check MV statuses or PID controller loops.

To help provide more accurate model identification in the presence of these and other problems, the model identification tool 154 can perform the following operations to support model identification. First, historical data is collected from one or more sources (such as one or more historians 141), and some of that historical data is automatically excluded from use in identifying a model. For example, data of poor quality and data having an incorrect or undesirable mode (such as data when a controller was in windup) can be excluded. Also, data outside of acceptable limits can be excluded. In addition, data away from average values by a user-provided standard deviation multiple can be excluded.

The model identification tool 154 then extracts informative data segments at desired resolution levels from the non-excluded data. In some embodiments, this can occur using a signal and a disturbance as described in U.S. Pat. No. 7,257,501 and U.S. Pat. No. 7,421,374 (both of which are hereby incorporated by reference in their entirety). A wavelet decomposition or other decomposition can be applied to the signal and disturbance, and singularity points can be detected in the decomposed signal. The edges thus detected at the desired resolution level can be used to convert the historical data into data segments to be analyzed further.

FIG. 3 illustrates one example of the data segments that could be generated during these operations. In FIG. 3, a graph illustrates values of various process variables over a specified time period. In the example shown in FIG. 3, a line 302 represents values of a single controlled variable (CV1) over the specified time period, and lines 304-308 represent values of three manipulated variables (MV1-MV3) that affect the controlled variable CV1 over the specified time period. Various vertical lines 310 in FIG. 3 denote the edges that could be detected using the approaches described in U.S. Pat. No. 7,257,501 and U.S. Pat. No. 7,421,374. These lines 310 divide the manipulated variable data into various data segments. Note that while FIG. 3 shows a single controlled variable and three manipulated variables, this approach could be used with any number(s) and type(s) of process variables.

Next, multiple-input single-output (MISO) model identification occurs in an iterative fashion. Various techniques are known in the art for performing MISO model identification. In some embodiments, the MISO model identification can be done with pseudo-random groupings of data segments for at least some of the iterations. One or more metrics (such as energy, SNR, or R square) are calculated for each segment and each independent variable (such as each MV and possibly each DV), and the metrics are used to recursively select the best-performing segment for each individual independent variable and to eliminate those segments that perform poorly. An “independent variable” generally refers to a process variable (an MV or DV) that affects another process variable, which is generally referred to as a “dependent variable.”

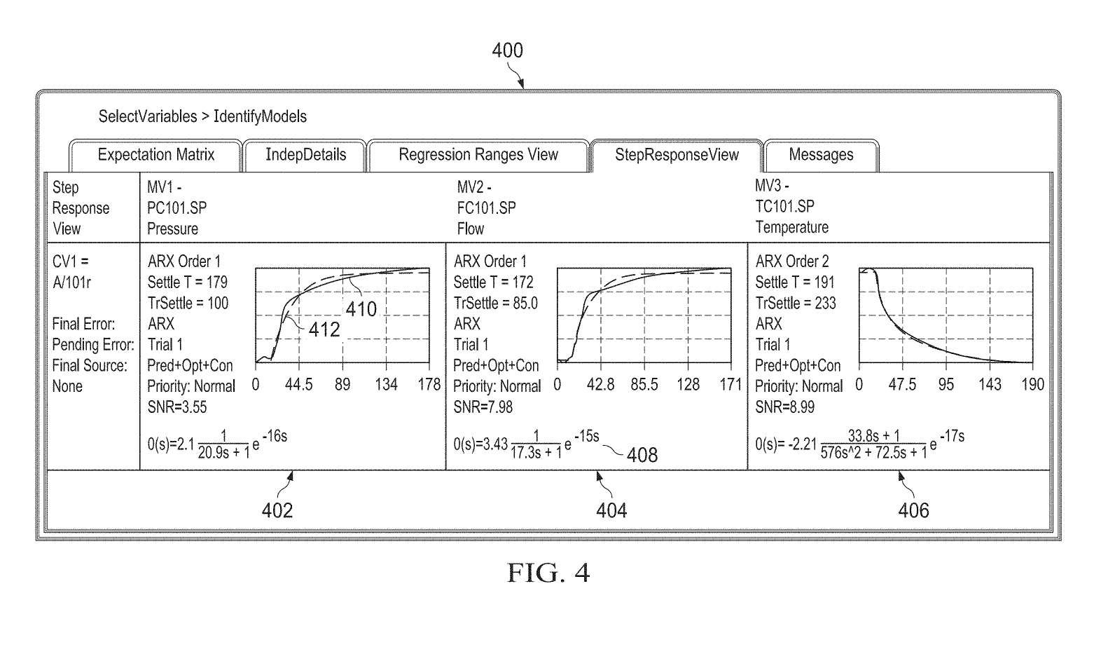

FIG. 4 illustrates one example of the models that could be generated during these operations. In FIG. 4, three models 402-406 have been generated using the data in FIG. 3. Each of these models 402-406 mathematically represents how the controlled variable CV1 responds to changes in one of the multiple manipulated variables MV1-MV3. Each model 402-406 here is expressed using a transfer function 408. The user interface 400 also contains two lines 410-412 for each model 402-406. The lines 410 represent the estimated behaviors of an industrial process, and the lines 412 represent the modeled behaviors of the industrial process based on the model 402-406. When the lines 410-412 for a model 402-406 closely match, this indicates that the model 402-406 accurately represents the expected behavior of the industrial process.

After the iterative process has selected one or more of the best-performing models, the selected models can be validated. For example, the selected models could be used in prediction and simulation modes to see how accurately the selected models would have represented the industrial process(es) during all of the identified data segments and during all of the historical data (even the excluded data).

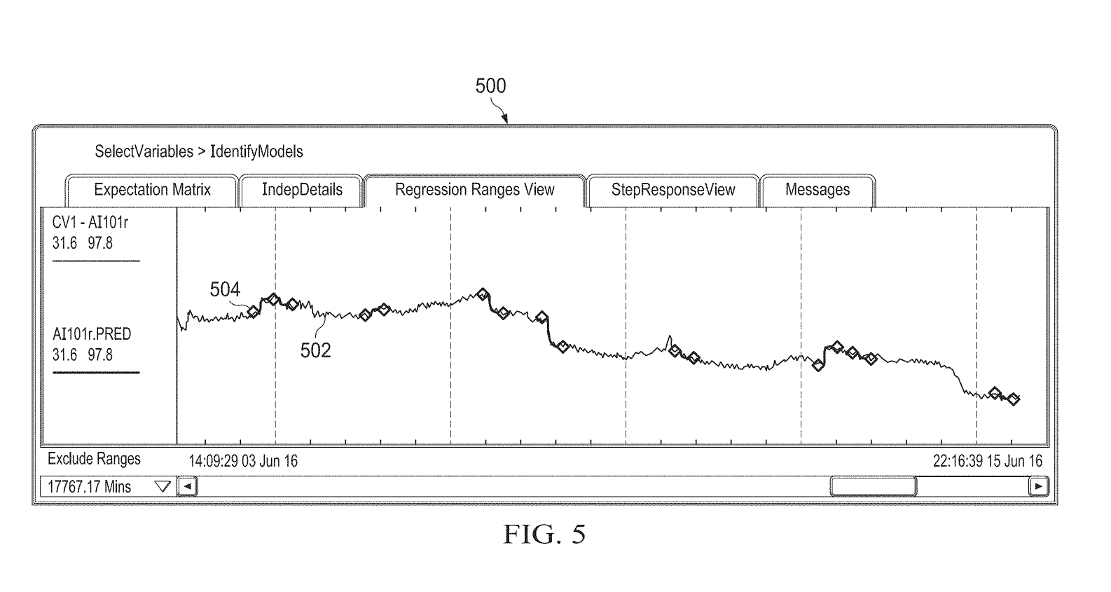

FIG. 5 illustrates one example of the validation results for a model that could be generated during these operations. In FIG. 5, a graph includes a line 502 that represents the actual values of the controlled variable CV1 during a given time period. Predictions of the values of the controlled variable CV1 during the given time period can be made using the selected models. One or more indicators 504 could be placed on the line 502 to identify when the predictions made using the selected models may differ from the actual values of the controlled variable CV1, such as by a specified amount or percentage.

Assuming the selected models are validated, those models could be used to build at least one model-based predictive controller. For example, the model identification tool 154 could provide the selected models to one or more process controllers (such as one or more controllers 106), which use the models as model 153a to control at least one industrial process. Also or alternatively, the models can be used for monitoring and tuning of one or more PID controllers, such as by altering one or more tuning parameters 153b of the PID controllers.

This model identification approach can be used in a number of scenarios. For example, when doing closed-loop model identification (such as is done in U.S. Pat. No. 8,295,952, which is hereby incorporated by reference), a model-based predictive controller using a seed model is often needed to control one or more industrial processes. The purpose of this seed model is not to provide perfect control but to maintain the overall industrial plant in a safe zone and not allow excessive excursions of controlled variables. Using the seed model, data associated with the one or more industrial processes can be obtained and used in the closed-loop model identification. The historical data-based model identification techniques described in this patent document can be used to develop the seed model.

The historical data-based model identification techniques described in this patent document can also be used in adaptive model identification to refine or adapt existing models, such as when a plant already has model-based predictive controllers that are operating using the existing models. This allows the existing models to be altered in order to account for things like changes in the underlying industrial process(es) being controlled. The historical data-based model identification techniques described in this patent document can further be used for monitoring PID controllers, such as by developing a PID process variable (PV) response to setpoint (SP) changes and comparing the response to a benchmark response. In addition, the historical data-based model identification techniques described in this patent document can be used for identifying a process model of a PID control loop using historical data, which can help with identification of better PID tuning parameters.

Although FIGS. 3 through 5 illustrate examples of user interfaces 300-500 showing various steps in a process supporting automatic model identification from historical data for industrial process control and automation systems, various changes may be made to FIGS. 3 through 5. For example, the user interfaces 300-500 here are used to represent example results that could be obtained using the historical data-based model identification techniques described in this patent document. However, the results need not be presented in user interfaces in the manner shown here.

FIG. 6 illustrates an example method 600 for automatic model identification from historical data for industrial process control and automation systems according to this disclosure. For ease of explanation, the method 600 is described as being performed using the device 200 of FIG. 2 in the system 100 of FIG. 1. However, the method 600 could be used with any other suitable device or system.

As shown in FIG. 6, historical data associated with at least one industrial process is obtained at step 602. This could include, for example, the processor 202 of the device 200 obtaining historical data associated with at least one industrial process from a process data historian 141 or other historical data source(s). The industrial process is associated with multiple independent variables, such as multiple manipulated variables and possibly one or more disturbance variables. As noted above, each independent variable is associated with one or more controlled variables (dependent variables) that are affected by that independent variable.

One or more portions of the historical data are automatically excluded at step 604. This could include, for example, the processor 202 of the device 200 identifying data of poor quality or data having an incorrect or undesirable mode (such as a specific controller mode). This could also include the processor 202 of the device 200 identifying data that is outside of acceptable limits or that is away from average values by a user-provided standard deviation multiple. Any other or additional criteria could be used to identify data to be excluded from use in model identification.

Data segments from one or more non-excluded portions of the historical data are automatically extracted at step 606. This could include, for example, the processor 202 of the device 200 using the techniques described in U.S. Pat. No. 7,257,501 and U.S. Pat. No. 7,421,374. As a particular example, this could include the processor 202 of the device 200 decomposing a signal and a disturbance associated with the historical data at a plurality of resolution levels, detecting a plurality of points in the decomposed signal using the decomposed signal and the decomposed disturbance, and extracting the data segments from the signal using the detected points.

Model identification is iteratively performed using the extracted data segments to identify one or more models at step 608. In FIG. 6, this is accomplished by recursively analyzing the extracted data segments at step 610. This could include, for example, the processor 202 of the device 200 recursively analyzing the extracted data segments to select the data segments associated with each independent variable that have a highest energy and provide a high signal to noise ratio. This could also include the processor 202 of the device 200 recursively analyzing the extracted data segments to eliminate poorly performing data segments associated with each independent variable. During this analysis, one or more metrics can be calculated for each data segment and each independent variable during each iteration of the model identification. The metrics can be used to select the best data segments for the independent variables. This is also accomplished by generating a model for each independent variable using the selected data segments for that independent variable at step 612. This could include, for example, the processor 202 of the device 200 generating a MISO model for each independent variable using the selected data segments for that independent variable.

The one or more models are used to design, monitor, or tune at least one industrial process controller for the at least one industrial process at step 614. As noted above, there are various ways in which the identified model or models can be used. This could include, for example, the processor 202 of the device 200 using the one or more models as one or more seed models during closed-loop model identification or as one or more updated or refined models during industrial process control. This could also include the processor 202 of the device 200 using the one or more models to monitor operation of at least one PID controller or to identify one or more tuning parameters for at least one PID controller. The one or more models could be used in any other suitable manner.

Although FIG. 6 illustrates one example of a method 600 for automatic model identification from historical data for industrial process control and automation systems, various changes may be made to FIG. 6. For example, while shown as a series of steps, various steps in FIG. 6 could overlap, occur in parallel, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining historical data associated with an industrial process, the industrial process associated with multiple independent variables;
automatically excluding at least one portion of the historical data;
automatically extracting data segments from at least one non-excluded portion of the historical data;
iteratively performing model identification using the data segments to identify one or more models; and
using the one or more models to design, monitor, or tune at least one industrial process controller for the industrial process;
wherein iteratively performing the model identification comprises:
recursively analyzing the data segments to (i) select the data segment or segments associated with each independent variable that have a highest energy and provide a high signal to noise ratio and (ii) eliminate poorly performing segments associated with each independent variable; and
generating a model for each independent variable using the selected data segment or segments for that independent variable.

2. The method of claim 1, wherein automatically extracting the data segments comprises:
decomposing a signal and a disturbance associated with the historical data at a plurality of resolution levels;
detecting a plurality of points in the decomposed signal using the decomposed signal and the decomposed disturbance; and
extracting the data segments from the signal using the detected points.

3. The method of claim 1, wherein the model for each independent variable comprises a multiple-input single-output (MISO) model.

4. The method of claim 1, wherein recursively analyzing the data segments comprises:
calculating one or more metrics for each data segment and each independent variable during each iteration of the model identification; and
using the metrics to select one or more best data segments for each independent variable.

5. The method of claim 1, wherein using the one or more models comprises:
providing the one or more models to the at least one industrial process controller as one or more seed models for closed-loop model identification.

6. The method of claim 1, wherein using the one or more models comprises:
providing the one or more models to the at least one industrial process controller as one or more updated or refined models for industrial process control.

7. The method of claim 1, wherein using the one or more models comprises:
using the one or more models to monitor operation of at least one proportional-integral-derivative (PID) controller.

8. The method of claim 1, wherein using the one or more models comprises:
using the one or more models to identify one or more tuning parameters for at least one proportional-integral-derivative (PID) controller.

9. An apparatus comprising:
at least one processor configured to:
obtain historical data associated with an industrial process, the industrial process associated with multiple independent variables;
automatically exclude at least one portion of the historical data;
automatically extract data segments from at least one non-excluded portion of the historical data;
iteratively perform model identification using the data segments to identify one or more models; and
use the one or more models to design, monitor, or tune at least one industrial process controller for the industrial process;
wherein, to iteratively perform the model identification, the at least one processor is configured to:
recursively analyze the data segments to (i) select the data segment or segments associated with each independent variable that have a highest energy and provide a high signal to noise ratio and (ii) eliminate poorly performing segments associated with each independent variable; and
generate a model for each independent variable using the selected data segment or segments for that independent variable.

10. The apparatus of claim 9, wherein, to automatically extract the data segments, the at least one processor is configured to:
decompose a signal and a disturbance associated with the historical data at a plurality of resolution levels;
detect a plurality of points in the decomposed signal using the decomposed signal and the decomposed disturbance; and
extract the data segments from the signal using the detected points.

11. The apparatus of claim 9, wherein the model for each independent variable comprises a multiple-input single-output (MISO) model.

12. The apparatus of claim 9, wherein, to recursively analyze the data segments, the at least one processor is configured to:
calculate one or more metrics for each data segment and each independent variable during each iteration of the model identification; and
use the metrics to select one or more best data segments for each independent variable.

13. The apparatus of claim 9, wherein the at least one processor is configured to provide the one or more models to the at least one industrial process controller as one or more seed models for closed-loop model identification.

14. The apparatus of claim 9, wherein the at least one processor is configured to provide the one or more models to the at least one industrial process controller as one or more updated or refined models for industrial process control.

15. The apparatus of claim 9, wherein the at least one processor is configured to at least one of:
use the one or more models to monitor operation of at least one proportional-integral-derivative (PID) controller; and
use the one or more models to identify one or more tuning parameters for the at least one PID controller.

16. A non-transitory computer readable medium containing instructions that when executed cause at least one processing device to:
obtain historical data associated with an industrial process, the industrial process associated with multiple independent variables;
automatically exclude at least one portion of the historical data;
automatically extract data segments from at least one non-excluded portion of the historical data;
iteratively perform model identification using the data segments to identify one or more models; and
use the one or more models to design, monitor, or tune at least one industrial process controller for the industrial process;
wherein the instructions that when executed cause the at least one processing device to iteratively perform the model identification comprise instructions that when executed cause the at least one processing device to:
recursively analyze the data segments to (i) select the data segment or segments associated with each independent variable that have a highest energy and provide a high signal to noise ratio and (ii) eliminate poorly performing segments associated with each independent variable; and
generate a model for each independent variable using the selected data segment or segments for that independent variable.

17. The non-transitory computer readable medium of claim 16, wherein the instructions that when executed cause the at least one processing device to automatically extract the data segments comprise instructions that when executed cause the at least one processing device to:
decompose a signal and a disturbance associated with the historical data at a plurality of resolution levels;
detect a plurality of points in the decomposed signal using the decomposed signal and the decomposed disturbance; and
extract the data segments from the signal using the detected points.

18. The non-transitory computer readable medium of claim 16, wherein the model for each independent variable comprises a multiple-input single-output (MISO) model.

19. The non-transitory computer readable medium of claim 16, wherein the instructions that when executed cause the at least one processing device to recursively analyze the data segments comprise instructions that when executed cause the at least one processing device to:
calculate one or more metrics for each data segment and each independent variable during each iteration of the model identification; and
use the metrics to select one or more best data segments for each independent variable.

20. The non-transitory computer readable medium of claim 16, wherein the instructions that when executed cause the at least one processing device to use the one or more models comprise instructions that when executed cause the at least one processing device to at least one of:
provide the one or more models to the at least one industrial process controller as one or more seed models for closed-loop model identification;
provide the one or more models to the at least one industrial process controller as one or more updated or refined models for industrial process control;
use the one or more models to monitor operation of at least one proportional-integral-derivative (PID) controller; and
use the one or more models to identify one or more tuning parameters for the at least one PID controller.
